(19) United States
(12) Patent Application Publication
(10) Pub. No.: US 2007/0078524 A1
(43) Pub. Date: Apr. 5, 2007

(54) Cuber feeder system and method

(75) Inventors: Michael McCauley, Dallas, TX (US); Bart Parish, Corinth, TX (US)

Correspondence Address: DUBOIS, BRYANT, CAMPBELL & SCHWARTZ, LLP, 700 LAVACA STREET, SUITE 1300, AUSTIN, TX, 78701, US

(73) Assignee: Balcones Fuel Technology, Inc.

(21) Appl. No.: 11/240,702

(22) Filed: Sep. 30, 2005

(51) Int. Cl. G05B 11/01

(52) U.S. Cl. 700/12

(57) ABSTRACT

A method and system for monitoring and controlling the feedstock during the processing of thermoplastics. The hardware of the present invention includes at least a sensor which outputs a signal proportional to the current drawn by main drive motor of the cuber, a programmable logic controller (PLC) which has a high calculation speed, and a variable speed drive (VSD) which is configured to stop, start, accelerate or decelerate the feedstock flow to the cuber based on instructions received from the PLC. The configuration of the present invention is such that the information provided to the PLC approximates real-time load information. The software used to monitor the feed rate into the cuber uses a modified proportional integral derivative (PID) algorithm in which the prime feedback input is a real-time electrical consumption signal derived from the motor driving the cuber. Because the torque required to process non-uniform feedstock varies widely, the system uses a two-stage feedback modulated loop. Initially, the feed rate is increased to a relatively high value at which point the first stage of the feedback modulated loop is engaged. At such time as a critical current threshold is reached and maintained for a certain period of runtime, the second stage of the algorithm is engaged in which the feeder is operating in a high pressure, low current configuration and is set to shut the system down if the current load exceeds a preset value.

### BACKGROUND OF THE INVENTION

1. Field

The system and method of the present invention pertains to the recycling of waste materials comprising cellulosic fiber and thermoplastic resin and, more particularly, to an improved method for feeding a cuber, or extruder, while processing recycled combustible materials into products capable of generating high heat outputs.

2. Background

An increasing number of consumer products are made from thermoplastic resin such as, for example, adhesive liners and medical gowns. Some consumer products, such as disposable diapers, are primarily made up of thermoplastic resin and cellulosic fiber wherein the thermoplastic material provides a moisture-proof lining on the outside of the diaper and the cellulosic fiber provides the bulky absorbent media on the inside. The cellulosic fiber holds and retains all moisture, while the thermoplastic material ensures that there is no external leakage.

When products such as diapers, adhesive liners, hygiene pads and the like are manufactured, a certain amount of waste is inevitable, resulting in so-called “pre-consumer waste.” The ultimate disposal of pre-consumer waste typically involves transporting it to the local landfill. Environmentalists abhor this type of disposal as being wasteful both in the manufacture and disposal of these products. For example, the manufacture of disposable diapers requires forest products to obtain the necessary cellulose and the disposal of the manufacturing waste utilizes valuable landfill space. Moreover, the U.S. Environmental Protection Agency (EPA) has placed increase restrictions on landfill requirements. For example, the EPA has recently enforced the requirement of double lining landfills for disposal of paper mill sludge. Consequently, there has been a dramatic increase in cost for establishing new landfills that comply with EPA requirements for paper mill by-products.

In addition to the increased reluctance to use forest products and increased restrictions in landfill requirements, there has also be an increase in demand for new sources of energy. Combustible products made from cellulosic fibers and thermoplastic resins offer a higher BTU output and provide a clean-burning alternative to conventional fuels. However, use of available cellulosic waste as a fuel source has achieved only limited acceptance to date. One reason for this is the relatively low heating value of cellulose as compared to, for example, coal. For example, cellulosic fibers alone can have a heating value of less than 7,000 BTU's per pound, while coal generally has heating value in excess of 9,000 BTU's per pound. Another problem is that many consumer products have substantial tear-resistant properties because the polymers are highly cross-linked or otherwise heavily processed, making these products exceptionally difficult to shred or extrude.

Methods and systems for processing materials consisting substantially of thermoplastic resin and cellulosic fiber into combustible materials are well known in the art. Typically, these processes typically consist of placing the materials in slow-speed, high-torque shredders where the material is shredded to a consistent size and then moved by a conveyor line to a “cuber,” or extrusion machine, where fuel cubes are extruded under pressure. However, there are a number of problems that arise with this process.

For example, in recent years, many companies have made significant advances in improving the tear-resistant properties of thermoplastic materials. These highly tear-resistant materials, by their very nature, are exceptionally difficult to process using conventional means. For example, if these materials are processed through normal shredder devices, the shredder will quickly become bound-up and, in many cases, cease operating. Moreover, because the materials are combustible by nature, they have a propensity for catching fire if exposed to high heat or friction, such as during processing. As a result, if the operator is successful in maintaining the operation of the shredder, the friction involved in processing these materials creates an extreme fire hazard.

There is a need, therefore, for an improved method for processing recycled combustible materials into products capable of generating high heat outputs and, in particular, for a system that will produce a consistent, predictable level of production. Because of the variety of materials included within the feeder stock, it is very common for the feeder to jam. Such jams are quite costly in terms of the downtime required to clear the jam as well as accumulating excessive wear on the machinery which results in an increase in the costs of both scheduled and non-scheduled maintenance. In addition, because the production level is inconsistent, it is difficult to integrate quantifiable and consistently measurable parameters into a closed loop system. In short, there is a need for a simple, highly intuitive system and method for feeding the cuber, in which all key system process parameters can be read at a glance and adjusted in a matter of moments.

There have been several different attempts in the past to create an effective feeder system. For example, one system fixes the feed rate at a percentage considerably lower than that which could potentially be supported by the process equipment. In this system, a rate is set on the variable speed drive (VSD) so that the greatest fluctuations in the cuber supply stream coupled with the minimum acceptable density/compressibility factors of the cubes would not exceed the ability of the cuber drive system to supply sufficient torque to the machinery to cube the input stream. This technique results in less jamming of the cuber, but employs the machinery at a rate significantly below its optimal potential so that plant production is artificially limited.

In another commonly used system, an operator sets the feed rate at a level significantly above that used in the above example. The person then attempts to monitor the cuber load factors using several means, including watching an ammeter displaying cuber motor current, listening to the sounds produced by the feeder and cuber, and “seat-of-the-pants” intuition. This technique results in short periods of high production, but greatly increases plant downtime due to jams resulting from over-feeding as well as outright equipment failure due to the machinery being exposed to significant overload situations occurring at a high frequency relative to overall runtime.

### BRIEF SUMMARY OF THE INVENTION

The present invention is for an improved system and method for controlling the feed into a cuber during the processing of products made of cellulosic fiber and thermoplastic resin. The hardware of the present invention includes at least a sensor which outputs a signal proportional to the current drawn by main drive motor of the cuber, a programmable logic controller (PLC) which has a high calculation speed, and a variable speed drive (VSD) which is configured to stop, start, accelerate or decelerate the feedstock flow to the cuber based on instructions received from the PLC. The configuration of the present invention is such that the information provided to the PLC approximates real-time load information.

The software used to monitor the feed rate into the cuber uses a modified proportional integral derivative (PID) algorithm in which the prime feedback input is a real-time electrical consumption signal derived from the motor driving the cuber. Because the torque required to process non-uniform feedstock varies widely, the system uses a two-stage feedback modulated loop. Initially, the feed rate is increased to a relatively high value at which point the first stage of the feedback modulated loop is engaged. At such time as a critical current threshold is reached and maintained for a certain period of runtime, the second stage of the algorithm is engaged in which the feeder is operating in a high pressure, low current configuration and is set to shut the system down if the current load exceeds a preset value.

### BRIEF DESCRIPTION OF THE DRAWINGS

A better understanding of the system and method of the present invention may be had by reference to the drawing FIGURE, wherein:

FIG. 1 shows a flow diagram of a process using the feed rate control method and system of the present invention.

### DETAILED DESCRIPTION

The present invention is an improved system and method for providing a feed stream to a cuber during the processing of products made of cellulosic fiber and thermoplastic resin. It should be appreciated that the present invention is equally applicable to the processing of products other than cellulosic fibers and thermoplastic resin.

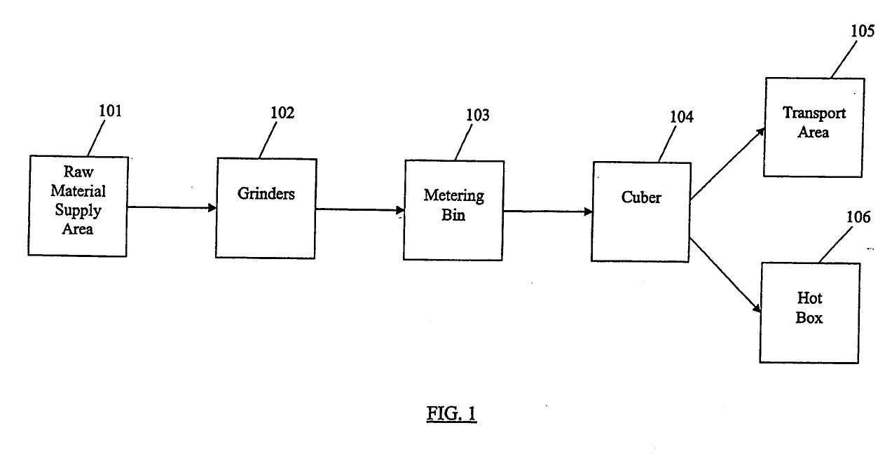

Referring now to the various figures of the drawing wherein like reference characters refer to like parts throughout the several views. FIG. 1 shows a flow diagram of a process in which remote monitoring of heating dies may be used. At the raw material supply area 101, feedstock is brought into the facility. The feedstock can consist, for example, of non-saleable waste materials from paper mills, such as disposable diapers, hygiene pads, hospital gowns and the like. The feedstock may be made up of thermoplastic material and cellulosic material. The thermoplastic material can be practically any available thermoplastic such as, but not limited to, polystyrene, polyethylene, polypropylene, acrylonitrile-butadienestyrene, acetal copolymer, acetal homopolymer, acrylic, polybutylene, and combinations thereof. However, thermoplastic materials most useful in the present invention are illustrated generally by the polyolefins such as polyethylene, polypropylene, polybutylene, and the like. Other thermoplastic resins are suitable so long as they have softening properties similar to the polyolefins, whereby they serve as lubricants for processing the feedstock, and as bonding agents to assist in bonding the layers together to make the finished combustible products.

For fast burning and ease of ignition of the fuel pellets, polypropylene and polyethylene are the preferred synthetic thermoplastic materials. In one embodiment of the invention, feedstock is approximately 60% non-chlorinated thermoplastic materials and 40% cellulosic fibers.

One skilled in the art will recognize that other materials may be processed with the feedstock such as, for example, to improve the combustibility of the finished product. Oxidizing agents such as sodium perchlorate and ammonium nitrate to facilitate combustion can be included in the feedstock. Materials such as comminuted tires, thermosetting resins and/or petroleum distillation residue can be added to improve the heating value of the finished product. Also, binding agents in addition to thermoplastic materials can be used. Exemplary of such binding agents are paraffin slack wax, carnuba wax, and lignosulfonates, such as ammonium lignosulfonate, sodium lignosulfonate, calcium lignosulfonate, and magnesium lignosulfonate.

Feedstock from the raw material supply area 101 is next fed into the grinders 102. As used herein, the term “grinder” refers to any device used for the purpose of reducing the size of the feedstock, including by grinding, shredding, pulverizing, chopping, granulating, crushing or the like. The purpose of the grinder 102 is to reduce the feedstock to a size suitable for passing through the cuber 104.

The ground feedstock is next passed through a cuber 104 consisting of an auger or augers, a press wheel and series of dies for the purpose of extruding the material into the desired shape. As the name implies, the cuber 104 can form the ground feedstock into cubes, however there are a number of other shapes that the cuber 104 may form that may be as, or more, desirable as combustible products. As used herein, the term “cube” refers to a discrete product of any size or shape that contains both cellulosic material and thermoplastic material. The cube need not be square or even symmetrical. While it may be useful to form the products in the shape of cubes, they can be any suitable symmetrical configuration such as the shape of a tube or a sphere. In one embodiment of the invention, elongated “cubes” are formed that are approximately 1 inch by 2 inches. The cuber 104 is operated at a pressure of between about 7,000 and 10,000 psi. The desired temperature of the dies, discussed further below, is about between 300 and 400 degrees Fahrenheit, with the temperature depending on the specific blend of the material and the moisture content in the feedstock. This combination of high pressure and temperature serves to seal the edges of the cubes. The processing of the ground feedstock at high heat creates a substantially water-impervious coating, or sheath on the outside of the combustible products, thereby both preventing uptake of moisture by the combustible products and resisting weathering in storage. Furthermore, the hydrophobic nature of the plastic prevents water uptake such that combustible products can be left out in the rain and still be readily processed in a furnace with no deterioration in heat output.

As described above, one difficulty in processing cubes in this manner is that, because the feedstock consists of a variety of materials with a variety of characteristics (e.g. moisture content), it is extremely difficult to create a consistent, predictable process. In one embodiment of the present invention, the feed rate is simplified to one discreet percentage variable so that the operator is only required to input that one variable: the percentage of the cuber's full speed which is to be set as the limit for the feed rate. The requested rate, as well as the actual rate as determined by the process calculations, are displayed on a graphical user interface (GUI) used to monitor and control the system. Accordingly, the operator only needs to intermittently check two simple integer percentages rather than continuously monitor a significant number of feed related analog (e.g. speed) and digital (e.g. discrete on-off) variables. In practice, once the feed rate is set, it can simply be ignored by the operator.

Feed control systems previously known in the art have been hardwired such that, when changes are required to be made to the system, they have been slow, costly and cumbersome. The present invention is configured so that significant changes in fundamental aspects of the feeder control system can be made quickly, at minimal expense, and in most cases remotely via an Internet link. For example, changing a plant over from one type of feedstock (e.g. waste paper) to another (e.g. carpet) could be done with a significantly lower expenditure of time and material than with a hardwired system.

The hardware of the present invention includes at least a sensor which outputs a signal proportional to the current drawn by main drive motor of the cuber, a programmable logic controller (PLC) which has a high calculation speed, and a variable speed drive (VSD) which is configured to stop, start, accelerate or decelerate the feedstock flow to the cuber based on instructions received from the PLC. The present invention uses a standard off-the-shelf programmable logic controller (PLC). In one embodiment, the PLC should have a high calculation speed and, with respect to the wide range of input/output modules it supports, a great breadth of ability to monitor real-world variables in real-time. Although the PLC does not run a true real time operating system, its input/output and calculation speed is so high as to yield essentially real-time performance in this application.

The sensor used in the present invention can be a standard commercial current transformer which outputs a signal proportional to the three phase AC current drawn by the cuber main drive motor. This is fed into a high speed analog to digital port attached to the PLC central processing unit. The speed of this entire conversion chain is such that the PLC, for all practical purposes, has real-time load information.

The VSD is controlled by a digital to analog converter driven by the PLC. This signal, like the input sensor, essentially responds in real time. Consequently, it is possible to stop, start, accelerate or decelerate the feedstock flow to the cuber with a latency limited only by the mechanical inertia of the material on the feeder conveyor belt.

In one embodiment of the present invention, software is used to monitor and control the feed rate into the cuber. The software uses a modified proportional integral derivative (PID) algorithm. However, in the present invention, the prime feedback input is a real time electrical consumption signal derived from the motor driving the cuber.

It will be recognized by those skilled in the art that a standard PID algorithm will not suffice in the present invention because, regardless of the degree to which the gain element is reduced, such an algorithm will be unresponsive. This is due to the fact that when the cuber load factor is plotted against input per unit time, the result is highly nonlinear. In order to produce the highest net output over time, it is necessary to increase the feed rate to a relatively high “floor” value, then engage the first stage of a two stage feedback modulated loop. After a critical current threshold is reached and maintained for a certain percentage of runtime, the second stage of the algorithm is engaged. This stage exhibits a high pressure, low current response with a “hair trigger” total feed cutoff at a critical level of current load. In normal operation the load factor is seen to climb rapidly up though the initial boost, taper off in stage one, and then “throttle” in stage two. When a maximum feed rate of greater than 100% is forced into the system by the operator, the system simply increases load up though the stages as described above and then settles at an appropriate interim point. However, those skilled in the art will recognize that, at any moment, a “spike” load may occur which will, depending on duration, either shift the system from stage one to stage two, or, if appropriate, completely shut down the system. This response is necessary due to the fact that even the most seemingly uniform of feedstock is inconsistent in the torque required to cube it, often to a significant degree.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of possible feed streams and processing equipment, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A method for controlling feedstock comprising:
outputting a signal from a sensor to a programmable logic controller wherein said signal is proportional to the current drawn by the drive motor of a cuber,
adjusting the speed or acceleration of the feedstock flow to the cuber based on instructions received from said programmable logic controller.

2. The method of claim 1 wherein said sensor out puts a current proportional to the three phase alternating current drawn by said drive motor of said cuber.

3. The method of claim 1 wherein the speed of said programmable logic controller approximates real time.

4. The method of claim 1 wherein said adjustment of the speed or acceleration of the feedstock flow to the cuber is controlled by a variable speed drive.

5. The method of claim 4 wherein said variable speed drive is controlled by a digital to analog converter driven by said programmable logic controller.

6. The method of claim 1 wherein said feedstock consists of recycled waste materials consisting of cellulosic fiber and thermoplastic resin.

7. A system for controlling feedstock comprising:
a sensor for outputting a signal to a programmable logic controller, wherein said signal is proportional to the current drawn by the drive motor of a cuber,
a device for transporting feedstock into said cuber, wherein the speed and acceleration of said device is adjusted based on instructions received from said programmable logic controller.

8. The system of claim 7 wherein said sensor out puts a current proportional to the three phase alternating current drawn by said drive motor of said cuber.

9. The system of claim 7 wherein the speed of said programmable logic controller approximates real time.

10. The system of claim 7 wherein said adjustment of the speed or acceleration of said device is controlled by a variable speed drive.

11. The system of claim 10 wherein said variable speed drive is controlled by a digital to analog converter driven by said programmable logic controller.

12. The system of claim 7 wherein said feedstock consists of recycled waste materials consisting of cellulosic fiber and thermoplastic resin.

13. A method for monitoring feedstock comprising:
monitoring the current draw on the motor used to deliver feedstock to a cuber;
establishing an initial rate at which said feedstock enters said cuber;
at such time as said current draw exceeds a first pre-set limit, reducing said rate at which said feedstock enters said cuber and monitoring said current draw so that, if said current draw exceeds a second pre-set limit, said feedstock is stopped from entering said cuber.

14. The method of claim 13 in which said current draw is monitored using a two-stage feedback modulated loop.

15. The method of claim 13 wherein said current draw exceeds said first pre-set limit for a pre-set period of time before reducing said rate at which said feedstock enters said cuber.

16. A method for monitoring feedstock comprising:
means for monitoring the current draw on the motor used to deliver feedstock to a cuber;
mans for establishing an initial rate at which said feedstock enters said cuber;
at such time as said current draw exceeds a first pre-set limit, reducing said rate at which said feedstock enters said cuber and monitoring said current draw so that, if said current draw exceeds a second pre-set limit, said feedstock is stopped from entering said cuber.

17. The method of claim 16 in which said current draw is monitored using a two-stage feedback modulated loop.
